(19) United States
(12) Patent Application Publication
(10) Pub. No.: US 2006/0248597 A1
(43) Pub. Date: Nov. 2, 2006

(54) Ubiquitous personal station with an external case and a control method thereof

(75) Inventor: Scott A. Keneman, Princeton, NJ (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/117,917

(22) Filed: Apr. 29, 2005

(51) Int. Cl. H04L 9/32

(52) U.S. Cl. 726/27

(57) ABSTRACT

A ubiquitous personal station including a personal processing unit and a case is provided. The personal processing unit includes a display for displaying information, a communication unit for communicating, and a processor for processing information. The case holds the personal processing unit, and includes an input unit on at least a portion of a surface of the case, a communicator for communicating with the communications unit such that when the case and personal processing unit are not in communication, the personal processing unit locks out at least one secured feature.

### FIELD OF THE INVENTION

This invention relates to ubiquitous personal station, and more particularly, to a ubiquitous personal station with an external case and a control method thereof to restrict functionality of a personal processing unit.

### SUMMARY OF THE INVENTION

A ubiquitous personal station includes a hand-held personal processing unit and a case to hold the personal processing unit. The personal processing unit includes a display for displaying information, a communication unit for communicating, and a processor for processing information. The case includes an input unit on at least a portion of its surface, a communicator for communicating with the communications unit such that when the case and personal processing unit are not in communication, the personal processing unit locks out at least one secured feature.

Another exemplary embodiment of the ubiquitous personal station includes a personal processing unit and a case to detachably hold the personal processing unit. The personal processing unit is slidably coupled with the case such that a display of the personal processing unit is configured to extend from the case and at least a portion of the display is rotatable relative to the case, and the personal processing unit includes the display for displaying information, a communication unit for communicating, and a processor for processing information. The case includes a communicator; and an input unit on at least a portion of a surface of the case for inputting information via the communicator to the personal processing unit.

Yet another exemplary embodiment of the ubiquitous personal station includes a personal processing unit and a case releasably coupled to the personal processing unit. The personal processing unit includes a display for displaying information, a communication unit for communicating, and a processor for processing information. The case includes one of a fabric flap or a transparent layer, such that the display is configured to be aligned therewith when the case is in a wrapped position, a communicator; and an input unit on at least a portion of a surface of the case for inputting information via the communicator to the personal processing unit, and a case position sensing unit for sensing whether the case is in the wrapped position, wherein when the case is sensed to be in the wrapped position, the input unit is disabled and when the case is not sensed to be the wrapped position, the input unit is enabled. The wrapped position refers to when the case substantially surrounds the personal processing unit.

Yet another exemplary embodiment of the ubiquitous personal station includes a personal processing unit and an input unit. The personal processing unit has at least one display for displaying information, a communication link for communicating, and an authentication unit to authenticate the user. The input unit, is separate from the authentication unit, and communicates with the personal processing unit for inputting information thereto such that the communication link is switched on when the user is authenticated.

The present invention is further embodied in a method to control the ubiquitous personal station having a personal processing unit and a case for releasably holding the personal processing unit. The method includes establishing a communication link between the processing unit and the case, when the case is close to the personal processing unit, and providing different predetermined levels of functionality for the personal processing unit according to whether the communication link is established.

Another exemplary embodiment of the control method includes authenticating the user using the authentication unit on the personal processing unit, and switching on a communication link between the personal processing unit and the input unit when the user is authenticated.

The present invention is further embodied in a computer readable medium for use with a ubiquitous personal station to store executable code to control the ubiquitous personal station according to a method. The method includes establishing a communication link between the processing unit and the case, when the case is close to the personal processing unit, and providing different predetermined levels of functionality for the personal processing unit according to whether the communication link is established.

Another exemplary embodiment of the computer readable medium to store executable code to control the ubiquitous personal station according to a method is provided. The method includes authenticating the user using the authentication unit on the personal processing unit, and switching on a communication link between the personal processing unit and the input unit when the user is authenticated.

### BRIEF DESCRIPTION OF THE DRAWINGS

The invention is best understood from the following detailed description when read in connection with the accompanying drawings. It is emphasized that, according to common practice, the various features of the drawings may not be drawn to scale. On the contrary, the dimensions of the various features may be arbitrarily expanded or reduced for clarity. Moreover in the drawings, common numerical references are used to represent like features. Included in the drawings are the following figures:

FIG. 1 is a functional block diagram illustrating a ubiquitous personal station according to an exemplary embodiment of the present invention;

FIG. 2A is a top view illustrating a ubiquitous personal station according to another exemplary embodiment of the invention in an unwrapped position;

FIG. 2B is a top plan view illustrating the ubiquitous personal station of FIG. 2A in a wrapped position;

FIG. 2C is a side plan view illustrating the ubiquitous personal station of FIG. 2B;

FIG. 3A is a top plan view illustrating the ubiquitous personal station according to yet another exemplary embodiment of the present invention in an extended position;

FIG. 3B is a top plan view illustrating the ubiquitous personal station of FIG. 3A in a retracted position;

FIG. 3C is a side plan view illustrating a ubiquitous personal station of FIG. 3A in a partially extended position;

FIG. 3D is a partial cross-sectional view illustrating a release device of the ubiquitous personal station of FIG. 3A;

FIG. 4A is top plan view illustrating the ubiquitous personal station according to yet another exemplary embodiment of the present invention in an unwrapped position;

FIG. 4B is a top plan view illustrating ubiquitous personal station of FIG. 4A in a partially unwrapped position;

FIG. 4C is a top plan view illustrating the ubiquitous personal station of FIG. 4A in a wrapped position;

FIG. 4D is a side view illustrating the ubiquitous personal station of FIG. 4A;

FIG. 5A is a top view illustrating the ubiquitous personal station according to yet another exemplary embodiment of the present invention;

FIG. 5B is a top plan view illustrating the ubiquitous personal station of FIG. 5A in a wrapped position;

FIG. 5C is a side view illustrating the ubiquitous personal station of FIG. 5A;

FIG. 6 is a flowchart illustrating a control method useable in any one of the exemplary embodiments of the present invention.

### DETAILED DESCRIPTION OF THE INVENTION

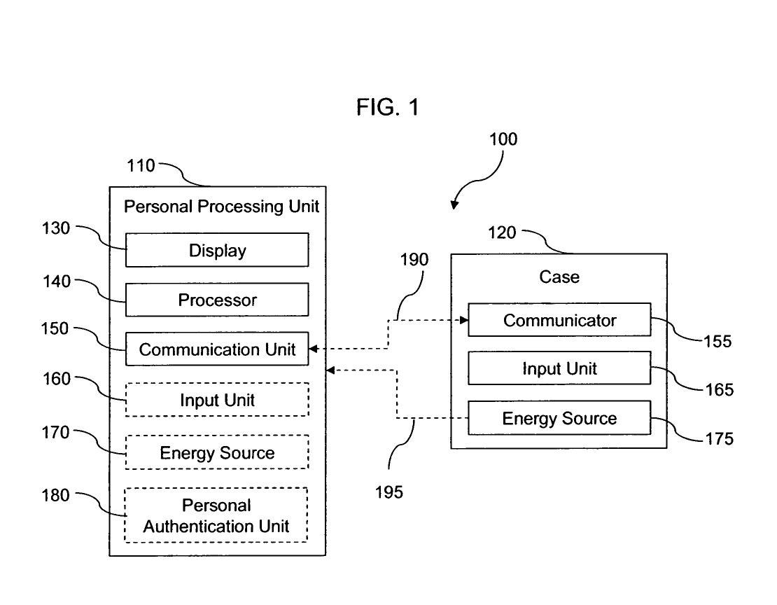

FIG. 1 is a functional block diagram illustrating operations of a ubiquitous personal station and generally refers to the various embodiments disclosed herein.

Referring to FIG. 1, ubiquitous personal station 100 includes a personal processing unit 110 and a case 120. Personal processing unit 110 includes a display 130, a processor 140, and a communication unit 150 and, optionally, an input unit 160, an energy source 170 and a personal authentication unit 180. That is, in the various exemplary embodiments of the present invention, input unit 160, energy source 170 and personal authentication unit 180 are optional. Case 120 includes a communicator 155, an input unit 165 and an energy source 175. Display 130 is configured to display information to a user. Processor 140 controls a display of the information by display 130 and functions of personal processing unit 110. Communication unit 150 of personal processing unit 110 communicates with communicator 155 of case 120 via a communication link 190, desirably a bi-directional communication link.

Some exemplary embodiments of the present invention may include input unit 160 of personal processing unit 110. In these exemplary embodiments input unit 160 may be any number of different input devices such as a folding keyboard, a partial keyboard, navigational buttons including at least one data entry key, a roller ball, a joy stick, and/or a joy stick button, among others.

Some exemplary embodiments of the present invention include an energy source 170 (e.g., a battery and/or photovoltaic cells) with the personal processing unit 110. This may be desirable to provide power to personal processing unit 110 when personal processing unit 110 is disconnected from case 120. In such a situation, for example, the battery may be included with personnel processing unit 110 and the energy source 170 may be accessible from an exterior surface of personnel processing unit 110 and may be chargeable by energy source 175 of case 120 or by photovoltaic cells electrically connected to personal processing unit 110 disposed on at least a portion of the exterior surface of personnel processing unit 110 to generate power for personal processing unit 110.

For example, in some exemplary embodiments, personal processing unit 110 may include a battery to power personal processing unit 110 and case 120 may further include a further battery to power electronics (e.g., communicator 155 and input unit 165) of case 120 and may be electrically connected to personal processing unit 110 when personal processing unit 110 is coupled with case 120 to provide at least supplemental power to personal processing unit 110.

Some exemplary embodiments of the present invention may include personal authentication unit 180 to authenticate the user (e.g., a biometric sensor, a handwriting analysis unit, and/or a password authentication unit).

It is contemplated that personal authentication unit 180 may use a combination of authentications including, for example, a combination of handwriting analysis analyzed via the handwriting analysis unit with a predetermined password authenticated via the password authentication unit or a combination of a biometric analysis such as a fingerprint analysis, or a retinal analysis, among others, using the biometric sensor with password authentication of the predetermined password authenticated via the password authentication unit.

In the exemplary embodiments that include personal authentication unit 180, personal authentication unit 180 may control switching-on and switching-off of communication link 190 such that personal processing unit 110 may have restricted functionality (i.e., not all of the functions are available to the user) when communication link 190 is switched off. Conversely, personal processing unit 110 may have full functionality when communication link 190 is switched on.

Input unit 165 of case 120 may communicate via communicator 155 over communication link 190 to personal processing unit 110. Input unit 165 may include for example, a full keyboard, a folding keyboard, a partial keyboard, navigation buttons including at least one data entry key, a roller ball, a joy stick device, and/or a joy stick button, among others. Moreover, case 120 may include energy source 175 (e.g., a battery) to provide power to input unit 165 and communicator 155 and may further provide, when a connection link 195 is established between personal processing unit 110 and case 120, power to personal processing unit 110.

Connection link 195 may be a hard-wired connection, a releasable connection, or any number of other connection types including, for example, an inductively coupled connection between case 120 and personal processing unit 110. That is, case 120 and personal processing unit 110 may be physically attached (i.e. coupled or tethered) to one another and power may be supplied from case 120 to personal processing unit 110 or, otherwise, personal processing unit 110 may be adjacent to case 120 and be supplied with power from case 120 via electromagnetic coupling.

In some exemplary embodiments of the present invention display 130 may be a touch screen display to allow information to be inputted thereto and also to be displayed thereon.

In some exemplary embodiments of the present invention, it may be desirable to include a clamshell type display having two display members pivotal with respect to each other. The display area for viewing may be increased by extending (i.e., opening) one of the display members so that both display members are viewable by the user. Moreover, for improved storage the dimensions of the clamshell type display may be decreased and the display area for viewing may be protected by retracting (i.e., closing) the display members of the clamshell display. Thus, a profile of personal processing unit 110 may be decreased when the clamshell display is closed.

In some exemplary embodiments of the present invention, communication link 190 may be: (1) a wired communication link such that communication is disabled (i.e., stopped) when the wired connection is disconnected or severed, (2) a wireless communication link, such as a wireless communication link using Bluetooth technology, following a IEEE 802 standard, or using a spread spectrum communication scheme, among others.

Communication between personnel processing unit 110 and case 120 is disabled when personnel processing unit 110 is out of range (i.e., not in operational vicinity) of case 120. In certain exemplary embodiments, when communication between personal processing unit 110 and case 120 are disabled (personal processing unit 110 and case 120 are not connected for a hard-wired communication link or are not within operational range for the a wireless communication link) and/or communication link 190 is not established), personal processing unit 110 may have restricted functionality (i.e., not all of the functions are available to the user). Moreover, when communication between personal processing unit 110 and case 120 are enabled (personal processing unit 110 and case 120 are connected for the hard-wired communication link or are within operational range for the wireless communication link and communication link 190 is established), personal processing unit 110 may have full functionality.

Certain functions of personal processing unit 110 may not be available during periods of restricted functionality. These restricted functions may be established for personal processing unit 110 according to either predetermined manufacturing settings or dynamically by secure procedures from ubiquitous personal station 100 when processor unit 110 is fully functional. For example, during periods of restricted functionality, personal processing unit 110 may only display incoming e-mail messages or the user may have only limited ability to view and scroll through e-mail messages without having functionality to input information into personal processing unit 110. That is, for example, in certain exemplary embodiments, input unit 160 may be locked out (i.e., information/commands from the user to input unit 160 may be ignored) during periods of restricted functionality.

In some exemplary embodiments of the present invention, communicator 155 may include hardware and/or software, for example, Read Only Memory (ROM) (not shown) to store, for example, a security code therein matched between personal processing unit 110 and case 120 such that personal processing unit 110 and case 120 only respond to communication from each other.

Although an example of restricted functionality is provided based on input unit 160 being locked out, it is contemplated that: (1) certain other devices such as communication unit 150 and/or display 130, among others; (2) certain functions such as e-mail functions, calendaring functions, editing functions, deleting functions and/or saving functions among others; and (3) certain objects such as secured data of personal processing unit 110 may have restricted access during periods of restricted functionality.

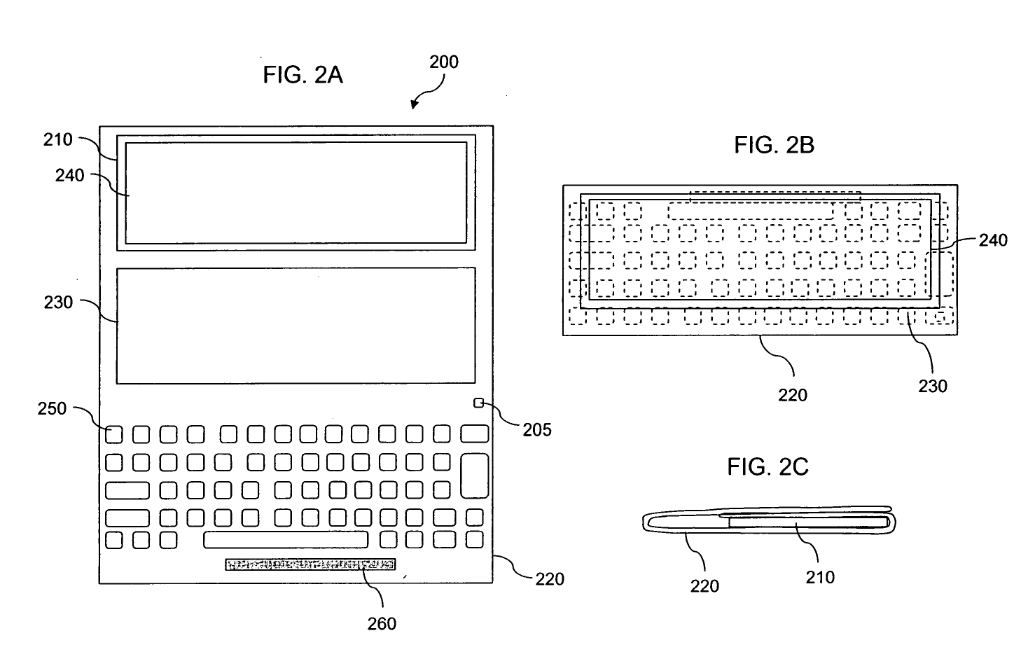

FIGS. 2A-2C are views illustrating a ubiquitous personal station according to another exemplary embodiment of the invention in which FIG. 2A illustrates the ubiquitous personal station configured in an unwrapped position, and FIGS. 2B and 2C illustrate the ubiquitous personal station configured in a wrapped position.

Referring now to FIG. 2A ubiquitous personal station 200 may include a personal processing unit 210 and a case 220 for detachably holding the processing unit 210. Case 220 may be made from a fabric material and may releasably surround (coupling with) personal processing unit 210. (See FIGS. 2B and 2C.)

As shown in FIGS. 2A-2C and disclosed above with reference to FIG. 1, personal processing unit 210 may include a display 240, a processor 140 for processing information, communication unit 150 and, optionally, energy source 170. Further, case 220 may include a window or fabric flap 230, energy source 175 (not shown in FIG. 2A, 2B or 2C), an input unit 250, and a case position sensing unit 205 for sensing whether case 220 is in a wrapped position. Input unit 250 may be disposed on at least a portion of a surface of the case and may communicate using communicator 155 and communication unit 150 for communicating via communication link 190 to personal processing unit 210, for example, to display information on display 240 or to process commands in personal processing unit 210. That is, communication link 190 is established between communicator 155 and communication unit 150.

Communication link 190 may be: (1) a hard-wired link to connect (tether) personal processing unit 210 to case 220; (2) a releasable link for tethered/connected operation of personal processing unit 210 with case 220 or unconnected operation of personal processing unit 210 without case 220; or (3) a wireless link for connected operation of personal processing unit 210 with case 220 or unconnected operation of personal processing unit 210 without the case 220.

Personal processing unit 210 may be releasably coupled to case 220, for example, by attachment strips (not shown) or coupling devices (not shown). Personal processing unit 210, when coupled with case 220, may be provided adjacent to a window (e.g., a transparent layer) or fabric flap 230 such that, when the ubiquitous personal station is in the wrapped position, display 240 may be viewed through window (e.g., a transparent layer) or fabric flap 230 of case 220 by a user. That is, one of the fabric flap or the transparent layer and display 240 may be configured to be aligned when case 220 is in the wrapped position. Further display 240, when the ubiquitous personal station is in the unwrapped position, may be viewed by the user without the use of window or fabric flap 230. Moreover, input unit 250 may be used, for example, to input information/commands to personal processing unit 210.

Case position sensing unit 205 may be disposed adjacent to input unit 250 to sense when case 220 is in the wrapped position and may output a signal via communicator 155 to personal processing unit 210 to disable input unit 250 when case 220 is sensed to be in the wrapped position and to enable input unit 250 when case 220 is sensed to be not in the wrapped position.

Display 240 may include a touch screen for inputting, for example, information when personal processing unit 210 is detached from case 220.

Attachment strip or coupling device 260 may be provided on two portions of case 220 such that, in the wrapped position, portions of case 220 are folded over each other and attachment strip or coupling device 260 may be attached to each other to maintain the wrapped position.

Referring now to FIGS. 2B and 2C, it is shown that ubiquitous personal station 200 may be configured into the wrapped position in which display 240 is aligned with window or fabric flap 230 of case 220 and attachment strips or coupling devices 260 are attached to maintain the wrapped position.

It is contemplated that electronics (i.e., circuits and elements for communicator 155, energy source 175 and input unit 250) may be integrated into case 220 or, otherwise, may be provided on circuit boards integrated with case 220. Case 220 may be flexible and may be made of fabric such that communicator 155, energy source 175 and input unit 250 may be integrated into the fabric of case 220 or, otherwise, may be provided on flexible circuit boards integrated with the fabric of case 220. The integration of such electronics is within the skill of one of ordinary skill in the art as disclosed, for example, in U.S. Pat. No. 6,585,162 by Sandbach et al. incorporated herein by reference. Moreover, it is known to provide photocells integrated into fabric (i.e., generate power from photocells integrated into fabric materials).

When case 220 and personal processing unit 210 are not in communication, personal processing unit 210 may lock out at least one secured feature. Moreover, when case 220 and personal processing unit 210 are in communication, personal processing unit 210 enables the use of the at least one secured feature (e.g., all secured features).

Case required functions of personal processing unit 210 may not be available during periods of restricted functionality. That is, for example the touch screen functionality of display 240 may be locked out (e.g., information and/or commands from the user inputted by the display 240 may be ignored) during periods of restricted functionality.

Although an example of restricted functionality is provided based on the touch screen functionality of display 240 being locked out, it is contemplated that certain devices, certain functions and certain objects may be restricted during period of restricted functionality.

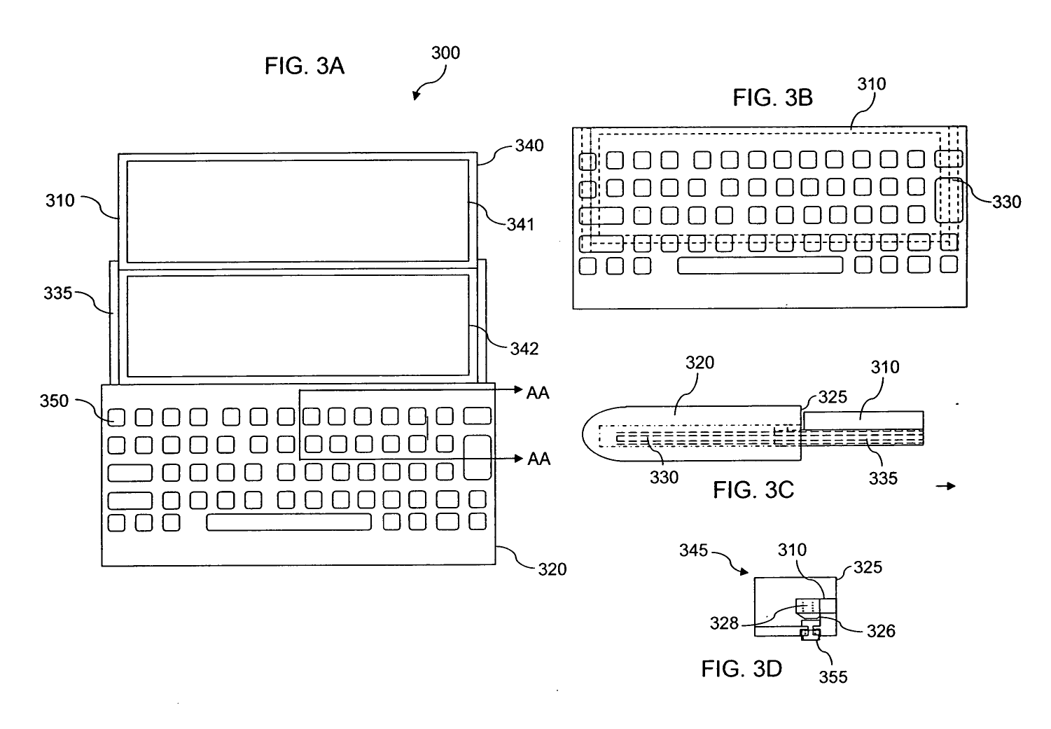

FIGS. 3A-3D are views illustrating a ubiquitous personal station according to yet another exemplary embodiment of the invention. FIG. 3A illustrates the ubiquitous personal station configured in an extended position. FIG. 3B illustrates the ubiquitous personal station configured in a retracted position. FIG. 3C illustrates a side plan view of the ubiquitous personal station in a partially extended position. FIG. 3D is a partial cross-sectional view of the ubiquitous personal station to illustrate a release device 345 thereof.

Referring now to FIG. 3A, ubiquitous personal station 300 may include a personal processing unit 310 and a case 320. Case 320 may be made from any number of different material including plastic, rubber, metal, or, desirably, a fabric material and may include an opening 325 formed in case 320 for detachably sliding personal processing unit 310 out of case 320 (i.e., case 320 releasably holds personal processing unit 310). As shown in FIGS. 3A-3C and disclosed above with reference to FIG. 1, personal processing unit 310 may include a display 340 for displaying information, a processor 140 for processing information to be displayed, communication unit 150 for communicating and, optionally, energy source 170 (not shown in FIG. 3) for providing power to personal processing unit 310. Further, case 320 may include an input unit 350 on at least a portion of a surface of case 320, energy source 175 (not shown in FIG. 3) and a communicator 155.

Input unit 350 may communicate with personal processing unit 310 via a communication link 190, for example, to provide commands to control processing in personal processing unit 310 or information for display to personal processing unit 310.

Case 320 may further include mounting units 330 on opposite sides of case 320 and personal processing unit 310 may include, sliding units 335, either as integral with personal processing unit 310 or as units mountable to personal processing unit 310, that slide relative to respective mounting units 330. Each mounting unit 330 and its corresponding sliding unit 335 are slideably and releasably coupled to each other though coupling grooves on one of the respective mounting units 330 and corresponding sliding units 335 and corresponding ridge projections on a remaining one of mounting units 330 and corresponding sliding units 335. That is, personal processing unit 310 may be slidably coupled with case 320 such that the display 340 of personal processing unit 310 extends from case 320 and at least a portion of personal processing unit 310 may be rotatable relative to case 320.

Display 340 may be a clamshell type display having a plurality of display members 341 and 342 pivotal with respect to each other. The display area for viewing by the user may be provided by extending (i.e., opening) display member 341 when personal processing unit 310 is in the partially extended position (see FIG. 3A) so that both display members 341 and 342 are viewable by the user. Moreover, for improved storage and protection of the display area for viewing, the clamshell type display 340 may be retracted (closed) by pivoting display member 341 of the clamshell type display 340 when personal processing unit 310 is in the extended position.

That is, the display may include plural display members 341 and 342 rotatably coupled together such that in the extended position, display 340 of personal processing unit 310 may slidably extend from case 320 and one display member 341 may rotate relative to a remaining display member 342 and in the retracted position display 340 may slidably retract into case 320 and display member 341 may be fixed relative to remaining display member 342 in case 320. Further, display 340 may include a touch screen for inputting information when personal processing unit 310 is detached from case 320.

Referring now to FIGS. 3B and 3C, it is shown that ubiquitous personal station 300 may be configured into the retracted position in which display 340 retracts into case 320 or into the partially extended position in which clamshell type display 340 is closed and projects from case 320.

As described above with reference to FIGS. 2A-2C, electronics may be integrated into case 320 or, otherwise, may be provided on circuit boards integrated with case 320. Case 320 may be flexible and may be made of fabric.

Although it is shown that personal processing unit 310 may include a clamshell type display 340 having a plurality of display members 341 and 342, it is contemplated that the personal processing unit 310 may include a plurality of members which are pivotal with respect to one another and may include one or more of display devices, input devices, and authentication units, among others. For example, personal processing unit 310 may include an input device on a member coupled with pivotal display member 341 such that when case 320 and personal processing unit 310 are in communication the input device may be enabled to interact with the display on display member 341 and when case 320 and personal processing unit 310 are not in communication the input device may not be enabled to interact with the processing unit, other functionalities, or the display on display member 341.

Although it is shown that personal processing unit 310 may include a clamshell type display 340 having a plurality of display members 341 and 342, it is contemplated that the personal processing unit 310 may include a single display member 342 coupled to case 320 by respective mounting and sliding units 330 and 335.

Referring now to FIG. 3D, ubiquitous personal station 300 may further include a release device 345 to selectively stop personal processing unit 310 from being separated from case 320, or, otherwise, to selectively release personal processing unit 310 from case 320. Release device 345 may be located adjacent to opening 325 and may include a release button 355 projecting from case 320. A releasable end stop 326 may be provided at one end portion of personal processing unit 310 to stop personal processing unit 310 from being separated from case 320 when not depressed and to allow release of personal processing unit 310 from case 320 when depressed. Further, a release button 355, which aligns with releasable end stop 326 when personal processing unit 310 is in the extended position, is configured to allow depression of releasable end stop 326 and release of personal processing unit 310. The exemplary releasable end stop 326 is spring biased by spring 328 to contact against case 320 in the extended position when not depressed by depressing release button 355. Further, releasable end stop 326 is profiled to allow personal processing unit 310 to be reattached to case 320 independent of operation of release button 355 by sliding sliding units 335 onto respective mounting units 330. The profile of personal processing unit 310 prevents personal processing unit 310 from being improperly slid into case 320, for example, backwards or sideways.

When personal processing unit 310 is in the retracted position, case 320 may substantially surround personal processing unit 310 to prohibit use of personal processing unit 310 and when personal processing unit 310 is in the extended position, personal processing unit 310 may be exposed to enable use thereof.

As described above with reference to FIGS. 2A-2C, case required functions of personal processing unit 310 may not be available during periods of restricted functionality. That is, for example, touch screen functionality of the display 340 may be locked out (i.e., information and/or commands from the user to input unit 350 may be ignored) during periods of restricted functionality.

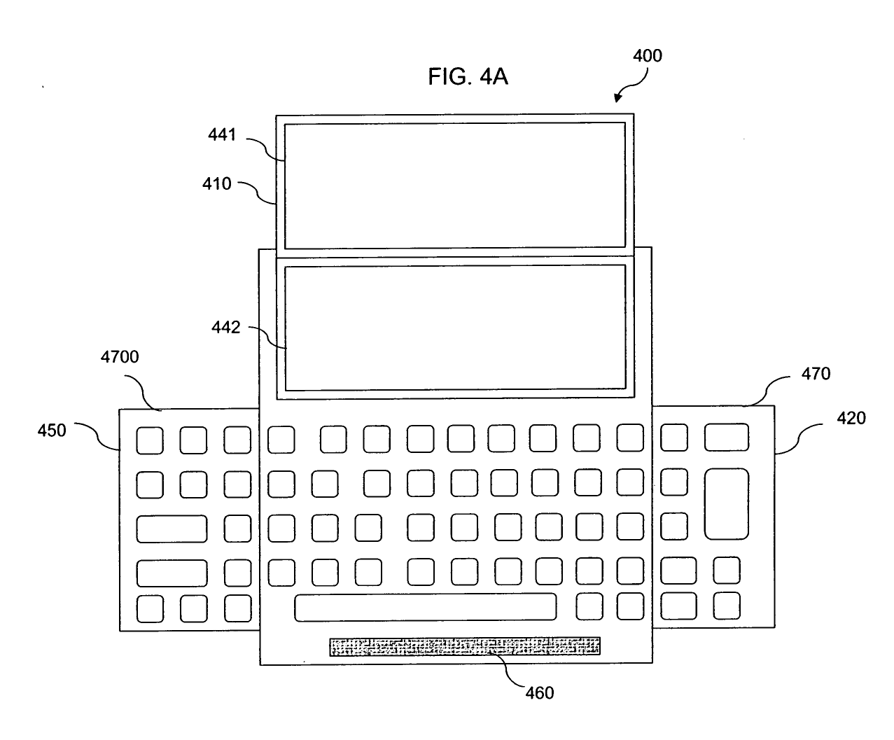

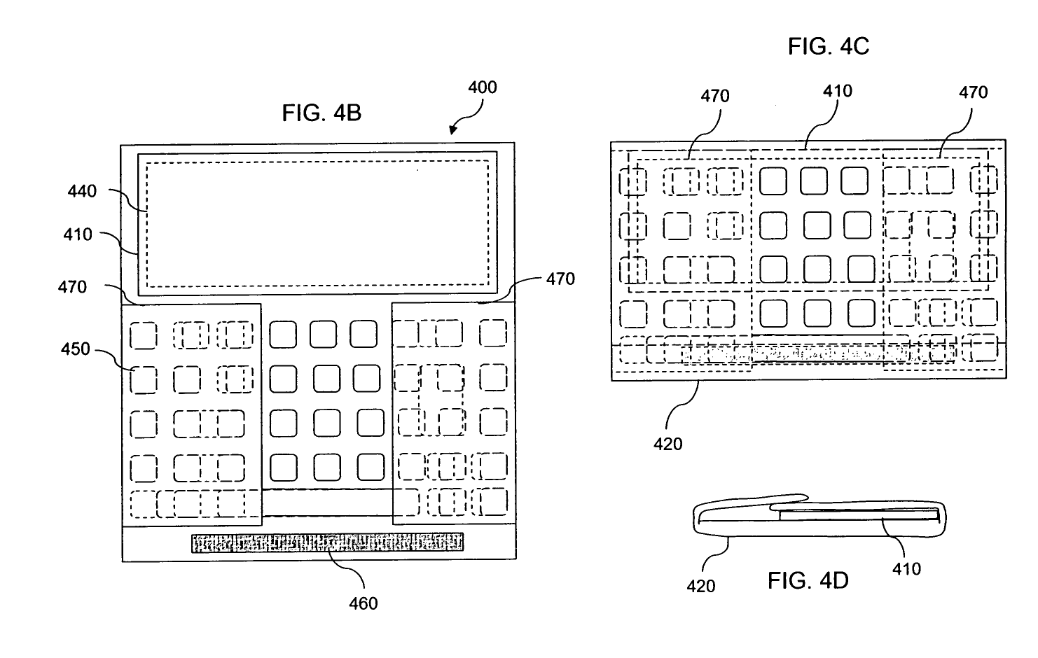

FIGS. 4A-4D are views illustrating a ubiquitous personal station according to yet another exemplary embodiment of the invention. FIG. 4A illustrates the ubiquitous personal station configured in an unwrapped position with an input unit of a case unfolded and a clamshell type display extended (i.e., opened). FIG. 4B illustrates the ubiquitous personal station configured in a partially wrapped position with the input unit folded and the clamshell type display retracted (i.e., closed). FIG. 4C illustrates the ubiquitous personal station configured in a wrapped position, and FIG. 4D illustrates a side plan view of the ubiquitous personal station in the wrapped position.

Referring now to FIG. 4A, ubiquitous personal station 400 may include a personal processing unit 410 and a case 420. Case 420 may be made from a flexible material, for example, a fabric material. As shown in FIGS. 4A-4D and disclosed above with reference to FIG. 1, Personal processing unit 410 may include a display 440 (see FIG. 4B), a processor 140, communication unit 150 and, optionally, energy source 170. Case 420 may include, communicator 155, energy source 175 and an input unit 450. Personal processing unit 410 may be releasably coupled via attachment strips or coupling devices (not shown) to case 420.

Input unit 450 may communicate via a communication link 190 to personal processing unit 410, for example, to provide commands and/or information to personal processing unit 410.

Communication link 190 may be: (1) a hard-wired link; (2) a releasable link for tethered/connected operation or unconnected operation; or (3) a wireless link for connected operation or unconnected operation of personal processing unit 410 without case 420.

Referring now to FIG. 4B, display 440 may be a clamshell type display having a plurality of display members 441 and 442 pivotal with respect to each other. The display area for viewing by the user may be provided by extending (i.e., opening) display member 441 when personal processing unit 410 is in the partially wrapped position so that both display members 441 and 442 are viewable by the user. Moreover, for improved storage and protection of the display area for viewing, the clamshell type display 440 may be retracted (i.e., closed) by pivoting display member 441 of the clamshell type display 440 when the personal processing unit 410 is in the unwrapped position. Further, display 440 may include a touch screen for input of information, for example, when personal processing unit 410 is detached from case 420.

Input unit 450 may be a flexible keyboard or other input device, for example, integrated into or onto a fabric material. Input unit 450 may include folding sections 470 configured to extend for additional keyboard functionality or other input devices or configured to retract for a more compact size of ubiquitous personal station 400.

Although input unit 450 is shown as a flexible keyboard, it is contemplated that it may be any number of other input devices such as a partial keyboard, navigation buttons, data entry keys, a roller ball device, a joy stick device, and/or a joy stick button, among others.

Although input unit 450 is shown having two folding sections 470, it is contemplated that it may have retracting/extending sections that slide into and out of case 420 or pivoting sections that pivot into and out of case 420. It is further contemplated that only a single folding, sliding or pivoting section may be provided.

As described above with reference to FIGS. 2A-2C, electronics may be integrated into case 420 or, otherwise, may be provided on circuit boards integrated with case 420. Case 420 may be flexible and may be made of fabric.

Referring now to FIGS. 4C and 4D, it is shown that ubiquitous personal station 400 may be configured into the wrapped position in which display 440 is in the retracted (i.e., closed) position and folding sections 470 are retracted (i.e., folded).

Attachment strips or coupling devices 460 may be provided on two portions of case 420 such that, in the wrapped position, portions of case 420 are folded over each other and attachment strips or coupling devices 460 may be attached to each other to maintain the wrapped position.

Although it is shown that personal processing unit 410 may include a clamshell type display 440 having a plurality of display members 441 and 442, it is contemplated that the personal processing unit 410 may include a plurality of members which are pivotal with respect to one another and may include one or more of display devices, input devices, and authentication units, among others.

For example, personal processing unit 410 may include at least one input device on a member coupled with pivotal display member 441 such that when case 420 and personal processing unit 410 are in communication the at least one input device is not disabled from interacting with the display on display member 441 and when case 420 and personal processing unit 410 are not in communication the at least one input device is disabled from interacting with the display on display member 441.

Personal processing unit 410 may be releasably coupled to case 420 and at least one of coupled display members 441 or 442 of personal processing unit 410 may project from an end of case 420.

Although it is shown that personal processing unit 410 may include a clamshell type display 440 having a plurality of display members 441 and 442, it is contemplated that the personal processing unit 410 may include a single display member 441 or 442 coupled to case 420.

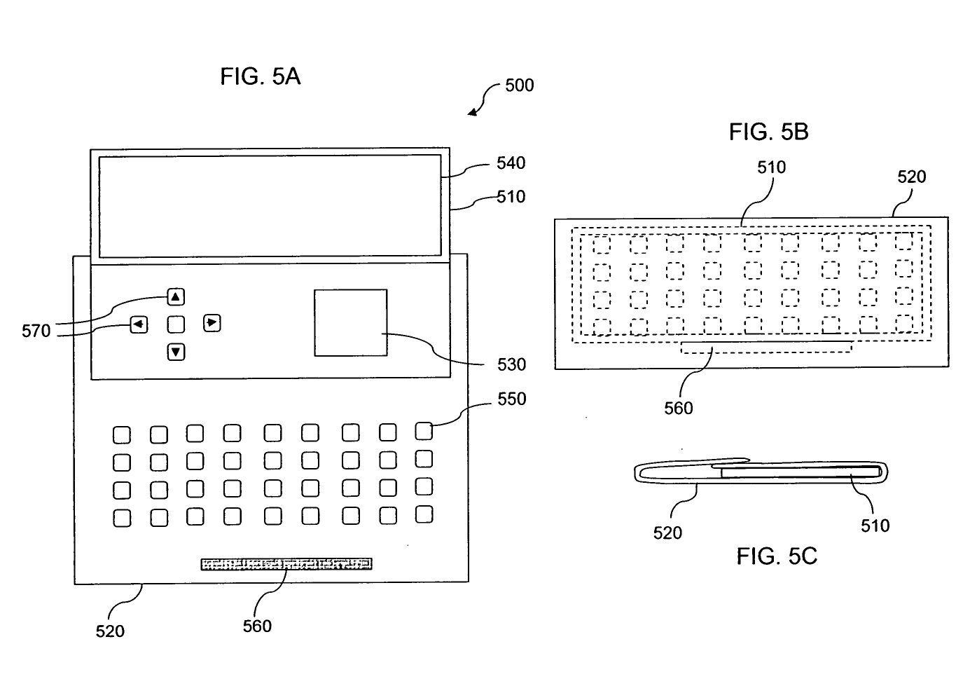

FIGS. 5A-5C are views illustrating a ubiquitous personal station according to yet another exemplary embodiment of the invention in which FIG. 5A illustrates the ubiquitous personal station configured in an unwrapped position with a clamshell type display extended (i.e., opened), and FIGS. 5B and 5C illustrate the ubiquitous personal station configured in a wrapped position.

Referring now to FIG. 5A, ubiquitous personal station 500 may include a personal processing unit 510 and a case 520. Case 520 may be made from a flexible material, for example, a fabric material, plastic, rubber and/or metal. As shown in FIGS. 5A-5C and disclosed above with reference to FIG. 1, personal processing unit 510 may include at least one display 540 for displaying information, a processor 140, communication unit 150 and, optionally, energy source 170. Further, case 520 may include, communicator 155, energy source 175 and an input unit 550. Personal processing unit 510 may be releasably coupled via attachment strips or coupling devices (not shown) to case 520.

Personal processing unit 510 may include a plurality of members 541 and 542 pivotal with respect to each other. Member 541 may include display 540 and member 542 may include, for example, navigational buttons including an entry button 570 for navigating through windows on display 540 and a personal authentication unit 530 to authenticate the user. When the display is extended (i.e., opened), member 541 may be viewed by a user.

Input unit 550 of case 520 may be a flexible keyboard or other input device, and may include, for example, folding sections 470 (see FIG. 4A) configured to extend for additional keyboard functionality or other input devices. Input unit 550 may be separate from personal authentication unit 530 for communicating with personal processing unit 510 to input information thereto such that communication link 190 is switched on when the user is authenticated.

Referring now to FIGS. 5B and 5C, it is shown that ubiquitous personal station 500 may be configured into the wrapped position in which display 540 is in the retracted (i.e., closed) position.

Attachment strips or coupling devices 560 may be provided on two portions of case 520 such that in the wrapped position, portions of case 520 are folded over each other and attachment strips or coupling devices 560 may be attached to each other to maintain the wrapped position.

Personal authentication unit 180 for authenticating the user may include, for example: (1) a biometric analyzer unit to scan and analyze fingerprints, retinal images, voice signals, and/or heart signals, among others, (2) a handwriting analysis unit to scan and analyze handwriting samples; and/or (3) a password authentication unit to input and analyze passwords.

As described above with reference to FIG. 1, personal authentication unit 530 may use a combination of authentications and may control switching-on and switching-off of communication link 190 such that personal processing unit 510 may have restricted functionality (i.e., not all of the functions are available to the user) when communication link 190 is switched off and personal processing unit 510 may have full functionality when communication link 190 is switched on. Further, case required functions of personal processing unit 510 may not be available during periods of restricted functionality. That is, for example, navigational/entry buttons 570 may be locked out (i.e., information and/or commands from the user through navigational/entry buttons 570 may be ignored) during periods of restricted functionality.

After personal authentication unit 530 authenticates the user, communication unit 150 is switched on. The user may then enter a predetermined password from input unit 550 to configure personal processing unit 510 for full functionality. Further, after a predetermined time since the last communication from the input unit 550 via communication link 190, personal processing unit 510 is placed back into restricted functionality operation and to obtain full functionality operation the user may re-authenticate via the personal authentication unit 530 and then by entering the predetermined password.

Although an example of restricted functionality is provided based on the navigational/entry buttons 570 being locked out, it is contemplated that certain devices, certain functions and/or certain objects may be restricted during period of restricted functionality.

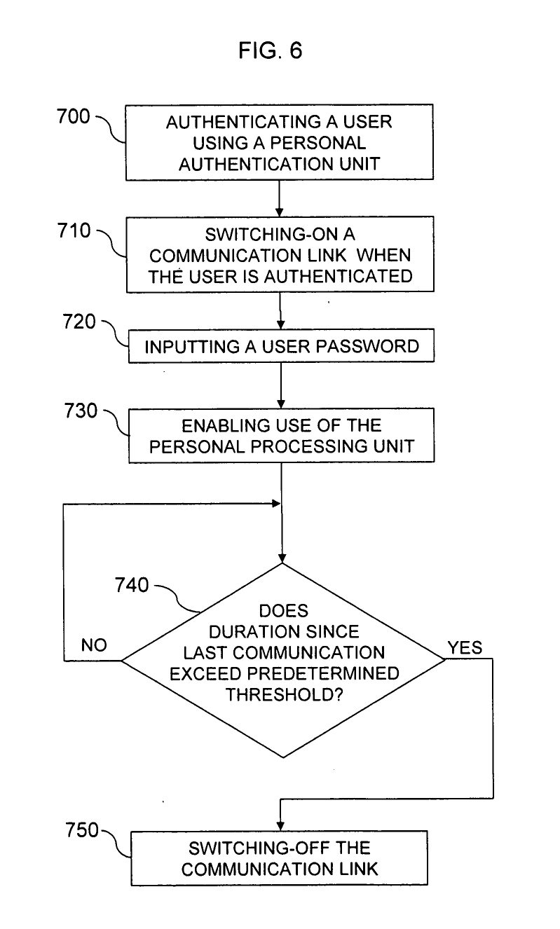

FIG. 6 is a flowchart illustrating a control method usable with any of the exemplary embodiments of the present invention described above.

Referring to FIG. 6, ubiquitous personal station 500 includes personal processing unit 510 including personal authentication unit 530 to authenticate a user and input unit 570, separate from personal authentication unit 530, for communicating with personal processing unit 510 and, at operation 700, the user may be authenticated using personal authentication unit 530 on personal processing unit 510. At operation 710, communication link 190 may be switched on between personal processing unit 510 and input unit 550 when the user is authenticated. At operation 720, a user password inputted from input device 550 may be validated responsive to establishment of communication link 190. At operation 730, use of the personal processing unit 510 may be enabled when the user password is validated. At operation 740, whether a duration of time since a last communication via communication link 190 exceeds a predetermined threshold may be determined. At operation 750, if the duration exceeds the predetermined threshold, the communication link 190 may be switched off.

The ubiquitous personal station of the various embodiments of the present invention may be implemented in a number of mediums. For example, the ubiquitous personal station may be a handheld device used as one or both of a personal data assistant and/or a gaming device. Further, control functions of the ubiquitous personal station may operate from a computer readable carrier (e.g., solid state memory, optical disk, magnetic disk, radio frequency carrier wave, audio frequency carrier wave, etc.) that includes computer instructions (e.g., computer program instructions) related to the ubiquitous personal station by executing instructions on at least the personal processing unit to provide a user-interactive handheld device.

Although the present invention has been largely described in terms of a ubiquitous personal station and a control methods to control the ubiquitous personal station, it is not limited thereto. As described herein, for example, the present invention may be embodied in software, in a machine (e.g., a microprocessor based appliance, etc.) that includes software in memory, or in a computer readable carrier configured to carry out the control scheme (e.g., in a self contained silicon device, a solid state memory, an optical disk, a magnetic disk, a radio frequency carrier wave, an audio frequency carrier wave, etc.).

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the scope of the invention.

What is claimed:

1. A ubiquitous personal station, comprising:
a personal processing unit including
a display for displaying information,
a communication unit for communicating, and
a processor for processing information,
a case for holding the personal processing unit and including
an input unit on at least a portion of a surface of the case,
a communicator for communicating with the communications unit such that when the case and personal processing unit are not in communication, the personal processing unit locks out at least one secured feature.

2. The ubiquitous personal station according to claim 1, wherein the case is a fabric casing releasably surrounding the personal processing unit.

3. The ubiquitous personal station according to claim 1, wherein the display includes at least two display members pivotably coupled together.

4. The ubiquitous personal station according to claim 1, wherein the personal processing unit further includes at least one input device coupled with the display such that when the case and personal processing unit are in communication the at least one input device is enabled to interact with the display and when the case and personal processing unit are not in communication the at least one input device is not enabled to interact with the display.

5. The ubiquitous personal station according to claim 1, wherein when the case and personal processing unit are in communication, the personal processing unit enables the use of the at least one secured feature.

6. The ubiquitous personal station according to claim 3, wherein the personal processing unit is releasably coupled to the case and at least one of the coupled display members of the personal processing unit projects from an end of the case.

7. A ubiquitous personal station, comprising:
a personal processing unit including
a display for displaying information,
a communication unit for communicating, and
a processor for processing information,
a case for detachably holding the personal processing unit, the personal processing unit being slidably coupled to the case such that the display of the personal processing unit extends from the case and at least a portion of the personal processing unit is rotatable relative to the case, wherein the case includes
a communicator; and
an input unit on at least a portion of a surface of the case for inputting information via the communicator to the communication unit of the personal processing unit.

8. The ubiquitous personal station according to claim 7, wherein the communication unit and the communicator communicate via a wireless communication link.

9. The ubiquitous personal station according to claim 7, wherein the case further includes a photovoltaic unit electrically connected to the personal processing unit when the personal processing unit is coupled to the case and formed on at least a portion of an external surface of the case to generate power for the personal processing unit.

10. The ubiquitous personal station according to claim 7, wherein the personal processing unit further includes a battery unit to power the personal processor and the case further includes a further battery unit to power the input unit and communicator and electrically connected to the personal processing unit when the personal processing unit is coupled to the case to provide at least supplemental power to the personal processing unit.

11. The ubiquitous personal station according to claim 7, wherein the display includes two display members rotatably coupled together such that in an extended position the display of the personal processing unit slidably extends from the case and one of the display members is rotatable relative to a remaining one of the display members and in the retracted position the display is slidably retracted into the case and the one display member is fixed relative to the remaining display member.

12. The ubiquitous personal station according to claim 7, wherein the display includes a touch screen for input of information when the personal processing unit is detached from the case.

13. A ubiquitous personal station, comprising:
a personal processing unit including
a display for displaying information,
a communication unit for communicating, and
a processor for processing information;
a case releasably coupled to the personal processing unit, and including
one of a fabric flap or a transparent layer, the one of the fabric flap or the transparent layer and the display configured to be aligned when the case is in a wrapped position,
a communicator,
an input unit on at least a portion of a surface of the case for inputting information via the communicator to the communication unit of the personal processing unit, and
a case position sensing unit for sensing whether the case is in the wrapped position,
wherein when the case is sensed to be in the wrapped position, the input unit is disabled and when the case is not sensed to be the wrapped position, the input unit is enabled.

14. The ubiquitous personal station according to claim 13, wherein the case is a fabric case such that when the display is in the retracted position, the fabric case substantially surrounds the personal processor device to prohibit use of the input unit and when the display is in the extended position, the input unit is exposed to enable use of the input unit.

15. The ubiquitous personal station according to claim 13, wherein the case and the personal processor device are detachable and the display includes a touch screen for input of information when the personal processing unit is detached from the case.

16. The ubiquitous personal station according to claim 13, wherein at least one of the communicator, the input unit or the case position sensing unit comprises a fabric circuit integrated into the fabric case.

17. The ubiquitous personal station according to claim 13, further comprising:
at least one photocell integrated into at least one portion of an exterior surface of the fabric case.

18. A ubiquitous personal station for use by a user, comprising:
a personal processing unit including:
at least one display for displaying information;
a communication link for communicating, and
an authentication unit to authenticate the user;
an input unit, separate from the authentication unit, for communicating with the personal processing unit via the communication link to input information thereto such that the communication link is switched on when the user is authenticated.

19. A method of controlling a ubiquitous personal station having a personal processing unit and a case for releasably holding the personal processing unit, comprising the steps of:
establishing a communication link between the processing unit and the case, when the case is in a vicinity of the personal processing unit; and
providing different predetermined levels of functionality for a personal processing unit according to whether the communication link is established.

20. The method according to claim 19, wherein the step of providing different predetermined levels of functionality for a personal processing unit includes locking out at least one secured function, when the communication link between the personal processing unit and the case is not established.

21. The method according to claim 19, wherein the step of providing different predetermined levels of functionality for a personal processing unit includes locking out at least one secured function, when a duration of time since a last communication from the communication link exceeds a predetermined threshold.

22. A method of controlling a ubiquitous personal station for use by a user, the ubiquitous personal station having a personal processing unit including an authentication unit to authenticate the user and an input unit, separate from authentication unit for communicating with the personal processing unit, comprising the steps of:
authenticating the user using the authentication unit on the personal processing unit; and
switching on a communication link between the personal processing unit and the input unit when the user is authenticated

23. The method according to claim 22, further comprising the steps of:
validating a user password inputted from the input device responsive to establishment of the communication link, and
enabling use of the personal processing unit when the user password is validated.

24. The method according to claim 22, further comprising the steps of:
determining whether a duration of time since a last communication via the communication link exceeds a predetermined threshold; and
if the duration exceeds the predetermined threshold, switching off the communication link.

25. A computer readable medium for use with a ubiquitous personal station to store executable code to control the ubiquitous personal station according to the method of claim 19.

26. A computer readable medium for use with a ubiquitous personal station to store executable code to control the ubiquitous personal station according to the method of claim 22.
